(19) United States
(12) Patent Application Publication
(10) Pub. No.: US 2012/0174017 A1
(43) Pub. Date: Jul. 5, 2012

(54) SYSTEMS, METHODS AND COMPUTER SOFTWARE FOR INNOVATION MANAGEMENT

(75) Inventors: Paul Tidwell, Leesburg, VA (US); Stuart Morgan, Reston, VA (US)

(73) Assignee: VeriSign, Inc.

(21) Appl. No.: 12/980,909

(22) Filed: Dec. 29, 2010

(51) Int. Cl. G06F 3/048

(52) U.S. Cl. 715/772

(57) ABSTRACT

An innovation management system and method are provided that automate a workflow through various stages, including identification of an innovation; collection of data about the innovation; assessment of the innovation; decision-making about whether/how to protect the innovation; submission of appropriate materials to obtain protection; and reassessment of the innovation after protection is in place. The system may prompt an innovator to establish an initial link between an innovation and an aspect of the business, such as a specific product line. The system may also facilitate assessment and reassessment of the innovation by prompting users to evaluate and modify the link between the innovation and the aspect of the business. The system may also generate customizable reports demonstrating a strength of the links between various innovations and various aspects of the business and/or product lines.

### FIELD OF THE INVENTION

The present invention is generally related to innovation management systems, methods, and computer software. More specifically, the present invention is related to automating innovation management and its various stages.

### BACKGROUND OF THE INVENTION

Companies struggle to organize and protect innovations and intellectual property (IP) assets, including patentable inventions, trade secrets, know-how, copyrights, trademarks, etc. Once an innovation is captured, a company may wish to link the innovation to the company's business, evaluate the value of the innovation, determine whether and how to protect the innovation with IP protections, etc. Present IP software systems, such as due date docketing systems, are of limited utility, mainly tracking deadlines related to IP protections, such as patent prosecution deadlines. A much more robust system is needed to capture and evaluate innovations, facilitate the protection process, and align IP with business objectives.

### SUMMARY OF THE INVENTION

Consistent with embodiments of the present invention, systems and methods are provided for gathering, tracking, discussing, and promoting inventions, from initial idea submission through filing and grant of a patent. In certain embodiments these systems and methods automate the building and maintenance of a patent pipeline, a patent portfolio, and associated business processes.

Systems and methods consistent with certain embodiments include a central repository for innovation-related business processes, data, reporting/tracking, and audit requests. The systems and methods capture and standardize innovation data, including innovation submissions from employees. An automated workflow may be generated to prompt the consideration of innovations and support decision-making around the type of intellectual property protections to be pursued. An interface may be provided for stakeholders, including business, technical, and legal personnel, to build and maintain a company's IP portfolio. Reports may be generated and analysis of the portfolio may be facilitated, for example, according to the company's business organization and product lines.

Systems and methods consistent with certain embodiments automate a process including various stages, such as identification of an innovation; collection of data about the innovation; assessment of the innovation; decision-making about whether/how to protect the innovation; submission of appropriate materials to obtain protection; and reassessment of the innovation after protection is in place.

Further, systems and methods consistent with certain embodiments facilitate interaction with innovators and inventors, as well as collaboration among stakeholders from technical, business, and legal roles. Graphical user interfaces enable users to view IP assets according to business units, product lines, etc. Reports, such as heat maps, may be generated to enable a company to make informed decisions about future investment in innovation, target resources for growth, identify potential opportunities for growth (either from within or via acquisition), etc.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a diagram of an organizational structure using an IP management tool, consistent with embodiments of the present invention.

FIG. 1A is a diagram illustrating an exemplary innovation management system, consistent with embodiments of the present invention.

FIG. 2 is a diagram of an IP management tool, consistent with embodiments of the present invention.

FIG. 3 is a screen shot of an exemplary innovation record, consistent with embodiments of the present invention.

FIG. 4 is a screen shot of an exemplary user interface for an IP management tool, consistent with embodiments of the present invention.

FIG. 5 is a screen shot of an exemplary user interface for an IP management tool, consistent with embodiments of the present invention.

FIG. 6 is a screen shot of an exemplary user interface for an IP management tool, consistent with embodiments of the present invention.

FIG. 6A is a screen shot of an exemplary user interface for an IP management tool, consistent with embodiments of the present invention.

FIG. 6B is a screen shot of an exemplary user interface for an IP management tool, consistent with embodiments of the present invention.

FIG. 6C is a screen shot of an exemplary user interface for an IP management tool, consistent with embodiments of the present invention.

FIG. 6D is a screen shot of an exemplary user interface for an IP management tool, consistent with embodiments of the present invention.

FIG. 7 is a screen shot of an exemplary user interface for an IP management tool, consistent with embodiments of the present invention.

FIG. 8 is a screen shot of an exemplary user interface for an IP management tool, consistent with embodiments of the present invention.

FIG. 8A is a screen shot of an exemplary heat map, consistent with embodiments of the present invention.

FIG. 8B is a screen shot of an exemplary heat map, consistent with embodiments of the present invention.

FIG. 8C is a screen shot of an exemplary user interface for an IP management tool, consistent with embodiments of the present invention.

FIG. 8D is a screen shot of an exemplary forecast heat map, consistent with embodiments of the present invention.

FIG. 9 is a screen shot of an exemplary user interface for an IP management tool, consistent with embodiments of the present invention.

FIG. 10 is a screen shot of an exemplary user interface for an IP management tool, consistent with embodiments of the present invention.

FIG. 11 is a flow chart of an exemplary IP management process, consistent with embodiments of the present invention.

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

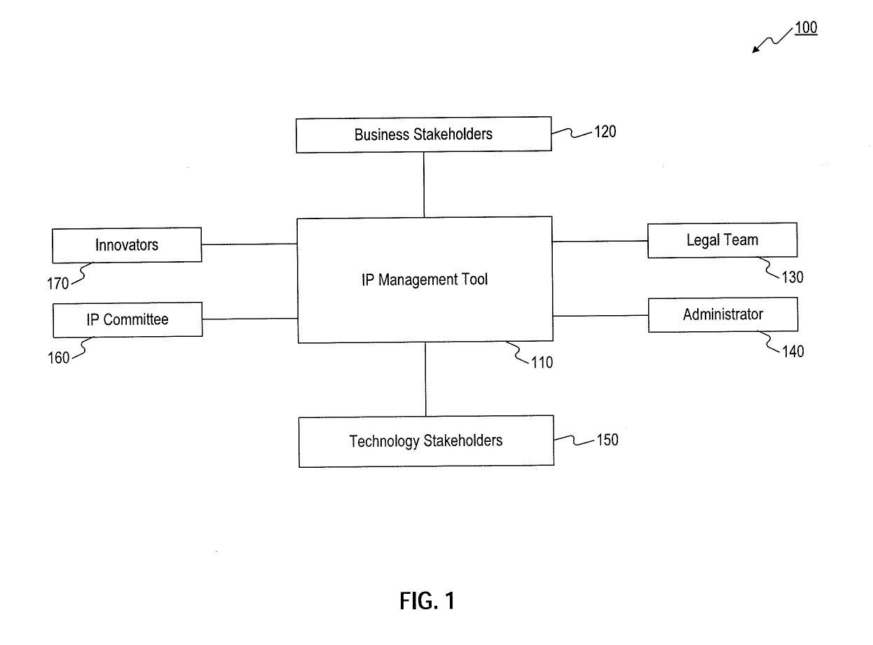

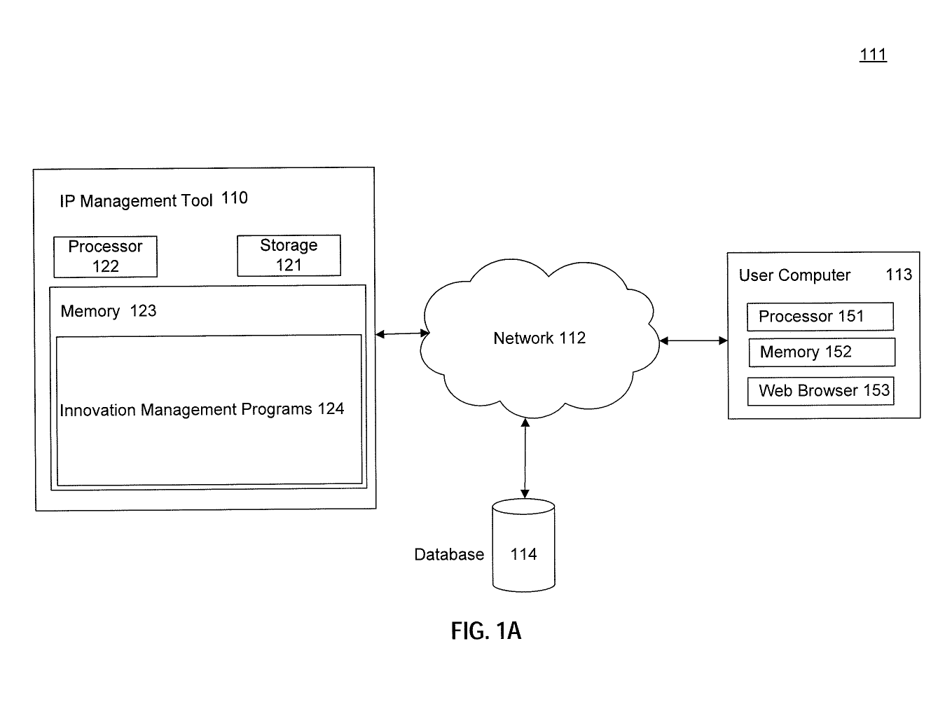

FIG. 1 is a diagram of an exemplary organizational structure 100 using an IP management tool 110, consistent with embodiments of the present invention. For example, several people within an organization, or from outside an organization, may interact with IP management tool 110, including business stakeholders 120, legal team 130, administrator 140, technology stakeholders 150, IP committee 160, and innovators 170.

For example, innovators 170 may develop new innovations and submit information about the innovations to IP management tool 110. These innovations may include, e.g., ideas that may be protectable via patents, trade secrets, copyrights, trademarks, etc. They also may include best practices, know-how, or other assets that an organization may document. As discussed in greater detail below, IP management tool 110 may receive information about these innovations and facilitate review of the innovations by different individuals or groups, e.g., business stakeholders 120, legal team 130, administrator 140, technology stakeholders 150, IP committee 160, etc. For example, in certain embodiments, IP management tool 110 may generate a workflow that lists action items to be completed in reviewing and protecting a certain innovation and manage the workflow for the different groups, prompting them to perform the action items.

IP management tool 110 may be implemented in any way consistent with embodiments of the present invention. For example, in certain embodiments, IP management tool 110 may be implemented in hardware and/or software on a stand-alone computer that is made accessible to the different groups shown in FIG. 1. Further, in certain embodiments, IP management tool 110 may be implemented as software on a computer server connected to a network, e.g., a local area network, wide area network, an organization's intranet, the Internet, etc. Users may interact with the IP management tool 110 over the network via browser-type interfaces on various user computers, e.g., laptops, desktop or tablet computers, cellular telephones, smart phones, personal digital assistants (PDAs), iPad™, etc.

FIG. 1A is a diagram illustrating an exemplary innovation management system 111 that may be used to implement disclosed embodiments, including exemplary system components. The components and arrangement, however, may be varied.

IP management tool 110 may include a processor 122, a memory 123, input/output (I/O) devices (not shown), and a nonvolatile storage 121. IP management tool 110 may be implemented in various ways. IP management tool 110 may be a general purpose computer, a server, a mainframe computer, or any combination of these components. IP management tool 110 may communicate over a link with network 112. For example, the link may be a direct communication link, a LAN, a WAN, or other suitable connection and may include the Internet.

Processor 122 may be one or more known processing devices, such as a microprocessor from the Pentium™ or Xeon™ family manufactured by Intel™, the Turion™ family manufactured by AMD™, or any of various processors manufactured by Sun Microsystems. Memory 123 may be one or more storage devices configured to store information used by processor 122 to perform certain functions related to disclosed embodiments. Storage 121 may be a volatile or non-volatile, magnetic, semiconductor, tape, optical, removable, nonremovable, or other type of storage device or computer-readable medium.

In one embodiment, memory 123 may include one or more innovation management programs or subprograms 124 loaded from storage 121 or elsewhere that, when executed by IP management tool 110, perform various procedures, operations, or processes consistent with disclosed embodiments. Memory 123 may also include other programs that perform other functions and processes, such as programs that provide communication support, Internet access, etc.

Methods, systems, and articles of manufacture consistent with disclosed embodiments are not limited to separate programs or computers configured to perform dedicated tasks. For example, memory 123 may be configured with innovation management program 124 that performs several functions when executed by processor 122. For example, memory 123 may include a single program 124 that performs the functions of the innovation management system, or program 124 may comprise multiple programs. Moreover, processor 122 may execute one or more programs located remotely from IP management tool 110. For example, innovation management tool 110 may access one or more remote programs that, when executed, perform functions related to disclosed embodiments.

Memory 123 may be also be configured with an operating system (not shown) that performs several functions well known in the art when executed by IP management tool 110. By way of example, the operating system may be Microsoft Windows™, Unix™, Linux™, Solaris™, an Apple Computers operating system, Personal Digital Assistant operating system such as Microsoft CE™, or some other operating system. The choice of operating system, and even to the use of an operating system, is not critical to any embodiment.

IP management tool 110 may include one or more I/O devices (not shown) that allow data to be received and/or transmitted by IP management tool 110. I/O devices may also include one or more digital and/or analog communication input/output devices that allow IP management tool 110 to communicate with other machines and devices, such as user computers 113 or databases 114. IP management tool 110 may receive data from external machines and devices and output data to external machines and devices via I/O devices. The configuration and number of input and/or output devices incorporated in I/O devices may vary as appropriate for certain embodiments.

IP management tool 110 may also be communicatively connected to one or more databases 114 through network 112. Databases 114 may store information related to innovations, for example. In some embodiments databases 114 may be separate from the IP management tool 110. In other embodiments, one or more of databases 114 may be stored at the IP management tool 110, such as in storage 121 and/or memory 123, for example.

IP management tool 110 may be communicatively connected to one or more user computers 113 through network 112. User computer 113 may include a processor 151, a memory 152, and a web browser 153 that enable it to communicate with IP management tool 110. IP management tool 110 may send data to processor 151 and web browser 153, and web browser 153 may display the data as a user interface. In some embodiments, IP management tool 110 may render the user interface and send the interface to web browser 153 for display. In other embodiments, IP management tool 110 may send the data used to create the interface to user computer 113 and user computer 113 may render the user interface.

User computer 113 may include I/O devices (not shown) to enable communication with a user. For example, the I/O devices may include one or more input devices, such as a keyboard, touch screen, mouse, and the like, that enable user computer 113 to receive data from a user. Further, user computer 113 may include I/O devices that communicate with one or more output devices, such as a display screen, CRT monitor, LCD monitor, plasma display, printer, speaker devices, and the like, that enable user computer 113 to present data to a user.

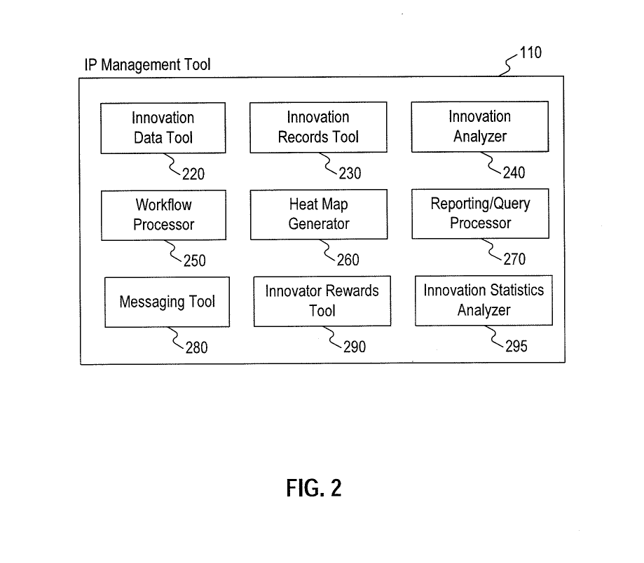

FIG. 2 is a block diagram of IP management tool 110, consistent with embodiments of the present invention. IP management tool 110 may include components such as innovation data tool 220, innovation records tool 230, innovation analyzer 240, workflow processor 250, heat map generator 260, reporting/query processor 270, messaging tool 280, innovator rewards tool 290, and innovation statistics analyzer 295. A skilled artisan will recognize that these components may be combined in many different ways, some components may be omitted or performed separately from IP management tool 110, etc.

Innovation data tool 220 may interact with innovators to obtain and manage data and documents regarding different innovations. For example if an innovator 170 at a user computer submits a new innovation to IP management tool 110, innovation data tool 220 may receive data related to the innovation. Further, innovation data tool 220 may prompt innovator 170 to enter additional quantitative and qualitative data regarding the innovation. For example, innovation data tool 220 may prompt innovator 170 to link the innovation to one or more aspects of the business, including, e.g., one or more products and to provide information related to the protection of the innovation.

When prompting innovator 170 to link the innovation to one or more aspects of the business, innovation data tool 220 may prompt innovator 170 to provide additional quantitative data regarding the strength of the link. This way, innovator 170 begins to document and build a relationship between the innovation and aspects of the business. For example, innovation data tool 220 may prompt innovator 170 to not only link the innovation to a product, but may also prompt innovator 170 to establish the strength of that link, e.g., the strength of the correlation between the innovation and the product. Moreover, innovation data tool 220 may prompt innovator 170 to indicate the features of a particular product with which the innovation corresponds as well as the strength of the link between the innovation and those features. For example, if product A has features 1, 2, 3, and 4, innovator 170 may indicate that the particular innovation has a high correlation to feature 1, a medium correlation to feature 2, and no correlation to features 3 and 4. While high, medium, and low are used as examples of link strength, any indicator may be used, e.g., a color system, a scale from one to ten, etc.

Innovation data tool 220 may also gather qualitative data from innovator 170. This information may include, e.g., which problems the innovation solves, the overall value of the innovation to the business, the best way to protect the innovation to preserve a competitive advantage in the market, etc. Innovation data tool 220 may then store the qualitative and quantitative data related to the innovation in a database, which may be included in IP management tool 110 and/or may be stored separately from IP management tool 110. This information may be used by innovation records tool 230, discussed below, to facilitate a review of the innovation and/or to further build and document the correlation between the innovation and different aspects of the business.

Innovation data tool 220 may also interact with innovators 170 and/or others such as business stakeholders 120, technology stakeholders 150, legal team 130, IP committee 160, etc., to obtain additional data and documents related to the innovation. For example, innovation data tool 220 may prompt innovator 170 to complete an innovation disclosure form that describes the innovation in additional detail. Innovation data tool 220 may also prompt innovator 170, technology stakeholders 150, and business stakeholders 120 to provide documents such as drawings, specifications, feasibility studies, market analysis, etc. Innovation data tool 220 may similarly store these documents in a database that may be the same as or different from the database in which innovation data tool 220 stored the initial data about the innovation.

In another example, data for prospective innovations may be provided to innovation data tool 220. For example, the prospective innovations may include innovations associated with an acquisition and/or innovations associated with innovation target goals within an organization. In these cases, a user other than innovator 170 may provide the innovation data to innovation data tool 220. For example, business stakeholders 120, technology stakeholders 150, or users from legal team 130 or IP committee 160 may provide information, e.g., the link between the innovation and different aspects of the business, the strength of the link, the best way to protect the innovation if not already protected, etc. In the example of an acquisition, if the organization from which the innovation was acquired also used IP management tool 110, a previously created innovation record for the innovation may also be obtained from the organization.

Innovation records tool 230 may use the data and/or documents received by innovation data tool 220 to generate an innovation record for an innovation. The innovation record may provide a summary of information regarding an innovation and allow users to track the progress of the innovation as it is processed by the IP management tool 110. For example, innovation records tool 230 may assign identifiers such as an innovation number, docket number, etc., to the innovation, and include such identifiers in the innovation record. Innovation records tool 230 may also query workflow processor 250 (discussed in greater detail below) to determine if a workflow has been generated for the innovation. If a workflow has been generated, innovation records tool 230 may include the workflow in the innovation record. In certain embodiments, innovation data tool 220 and innovation records tool 230 may be combined

Innovation analyzer 240 may facilitate an analysis of an innovation. For example, innovation analyzer 240 may prompt users of tool 110 to assess the innovation at different periods during the innovation's lifecycle. Based on these assessments, innovation analyzer 240 may receive information relating to the value of an innovation from users of tool 110. Innovation analyzer 240 may store this information in a database that may be the same as or different from the database in which innovation data tool 220 stored the initial data about the innovation. This information may then be processed and used in connection with reports such as those generated by heat map generator 260 and/or reporting/query processor 270 (discussed in greater detail below), for example. For example, innovation analyzer 240 may receive information regarding the scope of protection available for a certain innovation, the strength of a link between the innovation and different aspects of a business, the cost to implement an innovation, etc. Heat map generator 260 and/or reporting/query processor 270 may use this information to generate reports that can be accessed by users of tool 110 in order to assess an innovation.

Workflow processor 250 may generate a workflow for an innovation. For example, in the early stages of an innovation process, workflow processor 250 may generate a workflow that prompts users to determine how the innovation should be protected. For example, for a technical innovation, workflow processor 250 may receive an input from IP committee 160 that a patent is to be pursued for the technical innovation. In response, workflow processor 250 may prompt legal team 130 to prepare a patentability study and prompt business stakeholders 120, technology stakeholders 150, IP committee 160, and legal team 130 to collectively review the patentability study. If, after reviewing the patentability study, the users decide to pursue a patent for a particular innovation, workflow processor 250 may generate a workflow for the innovation that facilitates drafting, filing and prosecuting a patent application for the innovation, for example. As discussed above, innovation records tool 230 may query workflow processor 250 to obtain a workflow for an innovation, and may incorporate the workflow into the innovation record.

Heat map generator 260 may use information gathered by innovation data tool 220, innovation records tool 230, and/or innovation analyzer 240 to generate heat maps for one or more innovations. In some embodiments, heat maps, which are described in greater detail below, may demonstrate the links between one or more innovations and different aspects of an organization's business. For example, in certain embodiments, heat map generator 260 may generate a heat map that shows an organization's IP portfolio according to the organization's product hierarchy. The heat map may show the strength of a linkage between different innovations and different products, for example. This may enable an organization to determine which products are sufficiently protected and where to invest in additional innovation or acquisition. Moreover, as discussed in greater detail below, heat map generator 260 may generate forecast heat maps that use data received from innovation statistics analyzer 295 to generate what a heat map may look like at a point in the future due to internal innovation management and/or acquisitions or sales of innovations.

Reporting/query processor 270 may generate reports about one or more innovations based on a query entered by a user. For example, reporting/query processor 270 may allow a user to search for innovations meeting different search criteria, e.g., innovations related to specific aspects of the business, innovations being handled by certain outside counsel, innovations by status, innovations by title, etc. Reporting/query processor 270 may use information gathered by innovation data tool 220, innovation records tool 230, and innovation analyzer 240 and compare this information to the query entered by the user to generate a list of the innovations meeting the user's query. Thus, reporting/query processor 270 allows a user to search for different innovations based on specific search criteria.

Messaging tool 280 allows users to send messages to each other through IP management tool 110. For example, a business stakeholder 120 may pose a question regarding protecting an innovation to a user in legal team 130. In certain embodiments, messaging tool 280 may allow a user to access information gathered and generated by different components of IP management tool 110 and imbed them in the message. For example, if a business stakeholder 120 has a question regarding a heat map for a specific aspect of the company's business, he may imbed the heat map in the message being sent to the user in the legal group, so that the user in legal team 130 does not have to regenerate the heat map.

A user may also use messaging tool 280 to link a message with a particular innovation. For example, if a user wants to ensure that whenever other users access a certain innovation's record the users are informed of a particular message, the user may link a message with the innovation record so that it is displayed to all the users.

Innovator rewards tool 290 tracks innovator incentives for innovation. For example, innovator rewards tool 290 may automatically calculate rewards for innovators based on the status of their innovations. System administrator 170 may enter rules and requirements for such a program, including, e.g., the amount of the reward given for each type of innovation, how often rewards are to be distributed, how a reward is to be split by co-innovators, etc. Innovator rewards tool 290 may then automatically calculate the rewards for an innovator, establish a workflow for processing the rewards, etc.

Innovation statistics analyzer 295 may gather and analyze data regarding the lifecycles of different innovations. For example, innovation statistics analyzer 295 may gather data from innovation records tool 230 regarding timelines for the documentation, review, and protection of past innovations, and may use this information to project target dates for new innovations. In an example where one or more of the past innovations are patented inventions, innovation statistics analyzer 295 may calculate, for each of the past innovations, the duration from the date the application was filed to the date the patent was issued. Innovation statistics analyzer 295 may calculate the mean of these durations along with a standard deviation from the mean, for example. Innovation statistics analyzer 295 may group all of the patented inventions together when calculating the mean and standard deviation, and/or may separate the patented inventions into groups, e.g., by technology area, by art unit within the U.S. Patent and Trademark Office, by year the application was filed, etc.

Based on the calculated mean and standard deviation, the innovation statistics analyzer 295 may assign a forecast issue date to each innovation for which a patent application is pending. For example, innovation statistics analyzer 295 may determine that the mean time from filing to patent issuance for all of the organization's issued patents in art unit 2627 (related to information storage) is 39 months with a standard deviation of two months. In one embodiment, innovation statistics analyzer 295 may assume a normal distribution and determine that there is approximately a 95% chance that the application will issue within two standard deviations of 39 months, i.e. within 43 months. Thus, innovation statistics analyzer 295 may determine that a patent application in art unit 2627 that was filed on Mar. 1, 2008 will have a forecast issue date of Oct. 1, 2011. The forecast issue date may be stored along with the other data regarding the innovation and may be included in the innovation record generated by innovation records tool 230, for example.

While in the example above, innovation statistics analyzer 295 assigns a forecast issue date that is two standard deviations after the mean pendency period for past applications, one skilled in the art will understand that other statistical models may be used. For example, innovation statistics analyzer 295 may assign a forecast date to be equal to the mean, one standard deviation after the mean, three standard deviations after the mean, four standard deviations after the mean, any time in between the different standard deviations, etc. Moreover, innovation statistics analyzer 295 may use distributions other than a normal distribution. In some embodiments, the statistical model used by innovation statistics analyzer 295 may be configurable by a user, such as administrator 140, for example.

Innovation statistics analyzer 295 may also calculate the expiration dates for different innovations. For example, for issued patents, innovation statistics analyzer 295 may calculate when the patent will expire. Similarly, for pending patent applications, innovation statistics analyzer 295 may calculate the expiration date based on the forecast issue date.

Heat map generator 260 may use the data generated by innovation statistics analyzer 295 to generate forecast heat maps that display a heat map for all or part of an organization at a user-selected date in the future. For example, if a user selects a date three years in the future, heat map generator 260 may exclude all patents that innovation statistics analyzer 295 projects will be expired by that date. Similarly, heat map generator 260 may display the still pending patent applications for which innovation statistics analyzer 295 projects a forecast issue date within the next three years.

When generating a forecast heat map, heat map generator 260 may also include prospective innovation additions based on internal innovation target goals or potential acquisitions, as well as prospective innovation losses based on potential sales. For example, if a user indicates that certain innovations or groups of innovations will be sold off, heat map generator 260 may take this into account by removing them from the heat map. Similarly, if the user indicates that new innovations or groups of innovations will be acquired, heat map generator 260 may take this into account by adding these innovations to the heat map. As discussed above, for a potential acquisition of innovations, one or more users may enter innovation data, including a link between the to-be-acquired innovation and different aspects of the business, as well as a strength of that link. Heat map generator 260 may use this information in generating the forecast heat map for the acquired innovations.

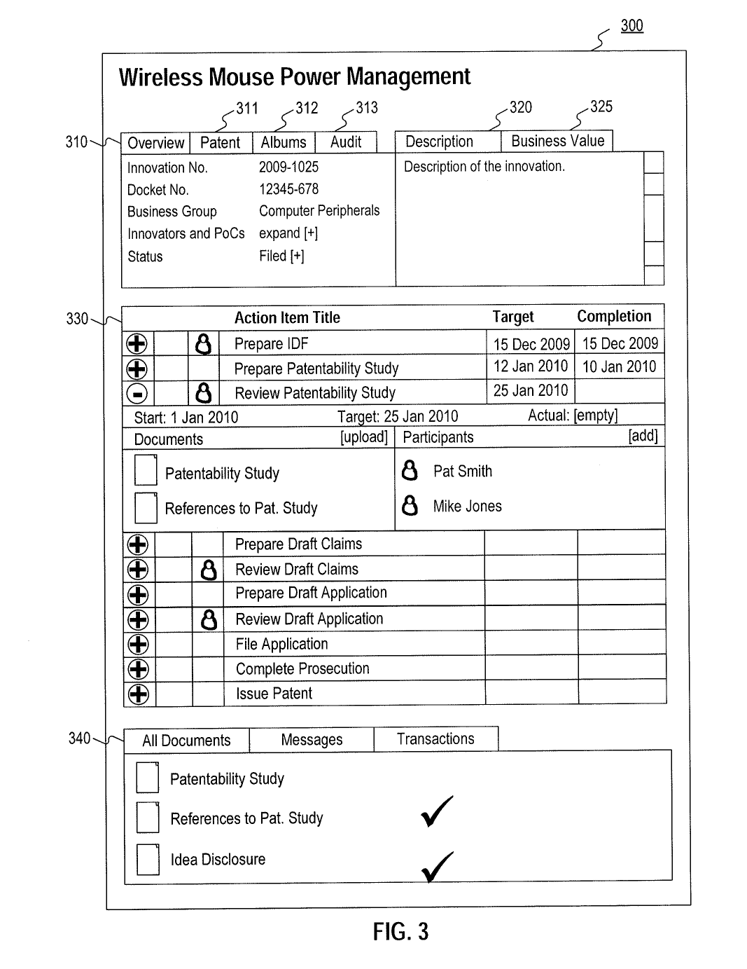

FIG. 3 shows a screen shot of an exemplary innovation record 300, consistent with embodiments of the present invention. Innovation record 300 may be generated by innovation records tool 230, for example. Innovation record 300 may include an overview portion 310, which includes identification information for an innovation, e.g., innovation number, docket number, business group, inventor(s), status, etc. In the example of FIG. 3, overview portion 310 shows that a wireless mouse power management innovation has been assigned an innovation number 2009-1025 and a docket number 12345-678 and has been linked to the Computer Peripherals business group.

Innovation record 300 may also include patent portion 311, for example, if the innovation is a patentable invention. Patent portion 311 may include information regarding the prosecution of the application, e.g., the legal owner of the patent application and/or patent; the firm responsible for prosecuting the application; identification information such as filing date, serial number, publication number, and/or patent number; the forecast issue date calculated by innovation statistics analyzer 295, etc.

Innovation record 300 may also include albums portion 312. Albums portion 312 may display albums that provide additional linking information for the innovation displayed in innovation record 300. For example, while overview portion 310 shows that the wireless power management innovation is linked to the business group “Computer Peripherals,” the innovation may also be linked to other innovations according to different criteria. For example, innovator 170 may create an album of all of the innovations for which he is the innovator. Moreover, technology stakeholder 150, who may be an engineering manager, for example, may create an album for all the innovations over which he exercises supervisory authority. Similarly, a project manager may create an album that groups together all of the innovations that came about as part of a certain project. For example, one project may generate innovations with uses that span business groups. Album portion 312 documents the link between the project and the different innovations.

Innovation record 300 may also include audit portion 313. Different users of IP management tool 110 may edit innovation record 300, e.g., by assessing and updating the links between the innovation and different aspects of the business, generating and updating workflows for the innovation, etc. Audit portion 313 includes a list of the edits that different users have made to innovation record 300.

Innovation record 300 may also include a description portion 320 that provides a brief description of the innovation and business value portion 325 that provides a description of the business value of the innovation. This information may be obtained, e.g., from the innovator's data provided to innovation data tool 220. The information may also be updated by users of IP management tool 110 as the innovation is assessed.

Innovation record 300 may also include a workflow section 330 that displays the workflow for a particular innovation, including action items. In the example shown in innovation record 300, the workflow indicates that a patentability study of the innovation related to wireless mouse power management has been performed, indicated by the completion date, and is awaiting review, indicated by the icon with a “minus” sign and the lack of a completion date for the action item “Review Patentability Study.” Additional action items related to the preparation and prosecution of a patent application directed to this innovation are also included in workflow section 330.

The workflow for a particular innovation may be generated automatically, may be generated manually by a user, such as administrator 140, for example, or a combination of both. For example, in one embodiment, a template of the steps to be performed for the particular workflow may be generated automatically by workflow processor 250. Administrator 140 may customize the workflow based on the particular innovation. For example, administrator 140 may add or remove steps from the workflow. Administrator 140 may also define which users should be responsible for different steps within the workflow for a particular innovation or for a group of innovations associated with a particular project or aspect of the business, for example.

A user viewing innovation record 300 may update the workflow as action items are completed. For example, when the patentability study is reviewed for the wireless mouse power management innovation, the user may enter the completion date into workflow section 330 for the action item “Review Patentability Study.” In certain embodiments, the workflow in the innovation record may only be updated by the user that is responsible for a particular action item. For example, Pat Smith and Mike Jones are responsible for reviewing the patentability study in workflow section 330. In certain embodiments, only Pat Smith and Mike Jones can update the workflow to indicate that the patentability study has been performed.

Innovation record 300 may also include informational section 340 which provides information regarding documents, messages, and transactions related to the innovation. For example, information section 340 may include documents that were collected by innovation data tool 220 and/or messages linked to a particular innovation by a user using messaging tool 280. A user may view the documents or messages by selecting them from the informational section 340, for example.

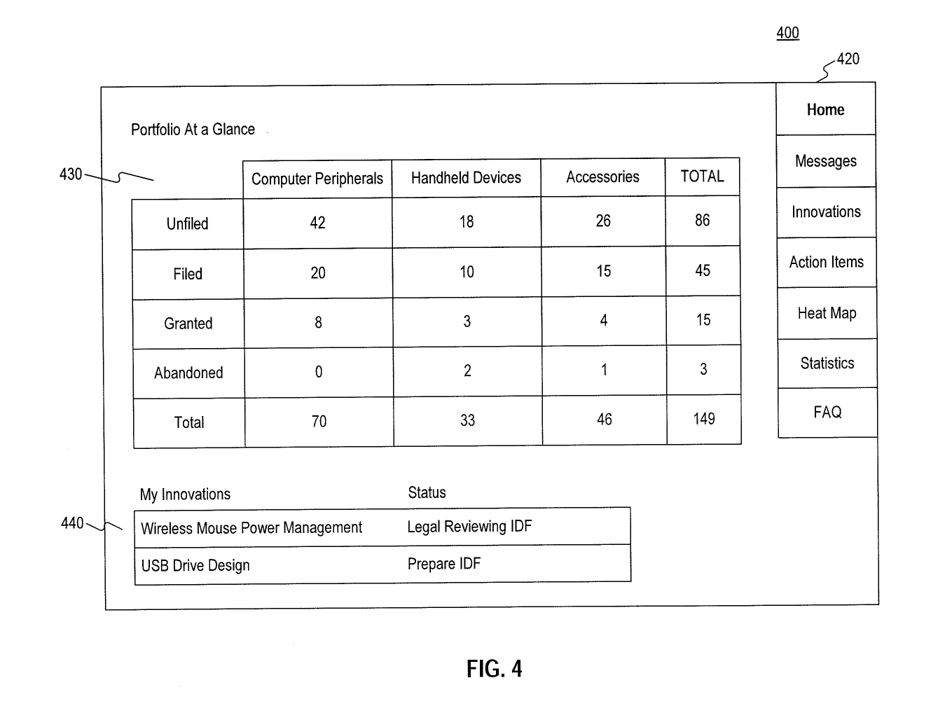

FIG. 4 is a screen shot of an exemplary user interface 400 for an IP management tool, consistent with embodiments of the present invention. User interface 400 includes a navigational toolbar 420 that allows a user to navigate between different aspects of IP management tool 110, for example. As can be seen from navigational toolbar 420, user interface 400 shows a home interface. At the home interface, user interface 400 includes a portfolio summary 430. Portfolio summary 430 provides a high-level status of the different innovations managed by IP management tool 110, sorted by different aspects of the business. The level of detail shown in the portfolio may be customizable by the user or by administrator 140. For example, the aspects of the business may be displayed with varying levels of generality, e.g., “computer peripherals” may be further broken down into products or product groups such as mouse (wired), mouse (wireless), keyboard, etc.

User interface 400 also includes an innovations list 440 that displays innovations to which a user is linked. For example, if the user is an innovator, the innovations list 440 may include the innovations for which the user is a named innovator. Innovations list 440 may also indicate a status for each of the innovations. The status displayed on the innovations list 440 may be the first action item in the innovation's workflow that has not been completed, for example.

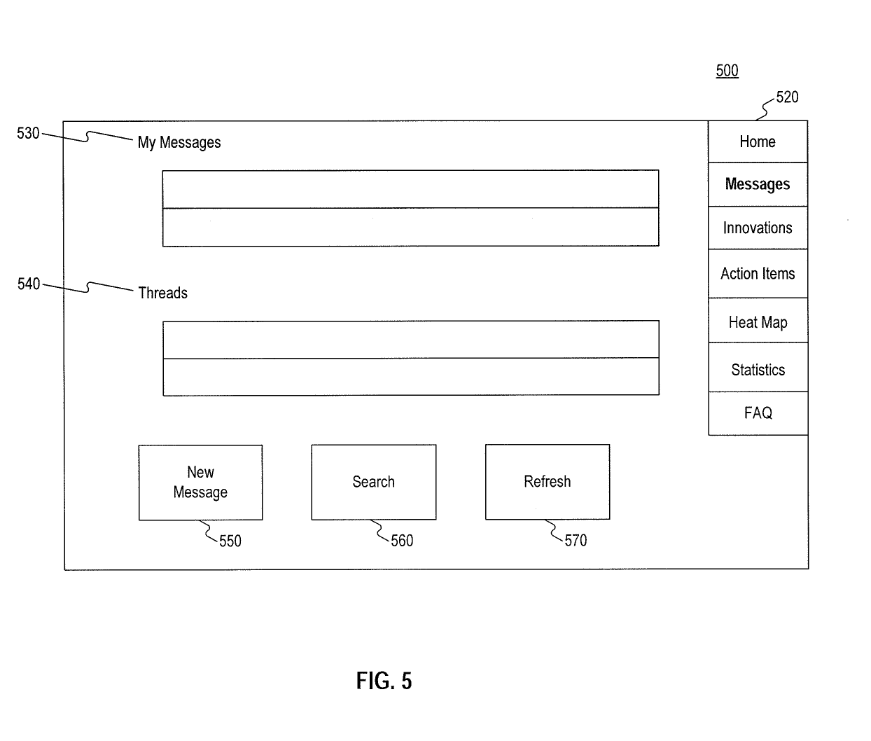

FIG. 5 is a screen shot of an exemplary user interface 500 for an IP management tool, consistent with embodiments of the present invention. As can be seen from navigational toolbar 520, user interface 500 shows a messages interface. User interface 500 may include a my messages section 530 which displays messages sent to a user. User interface 500 may also include a threads section 540 which displays threads related to the user. For example, if the user is associated with an innovation, threads section 540 may display the different discussion threads that correspond to the innovation associated with the user. User interface 500 may also include a new message button 550 for generating a new message, a search button 560 for searching among messages and/or threads, and a refresh button 570 for refreshing my messages section 530 and/or threads section 540.

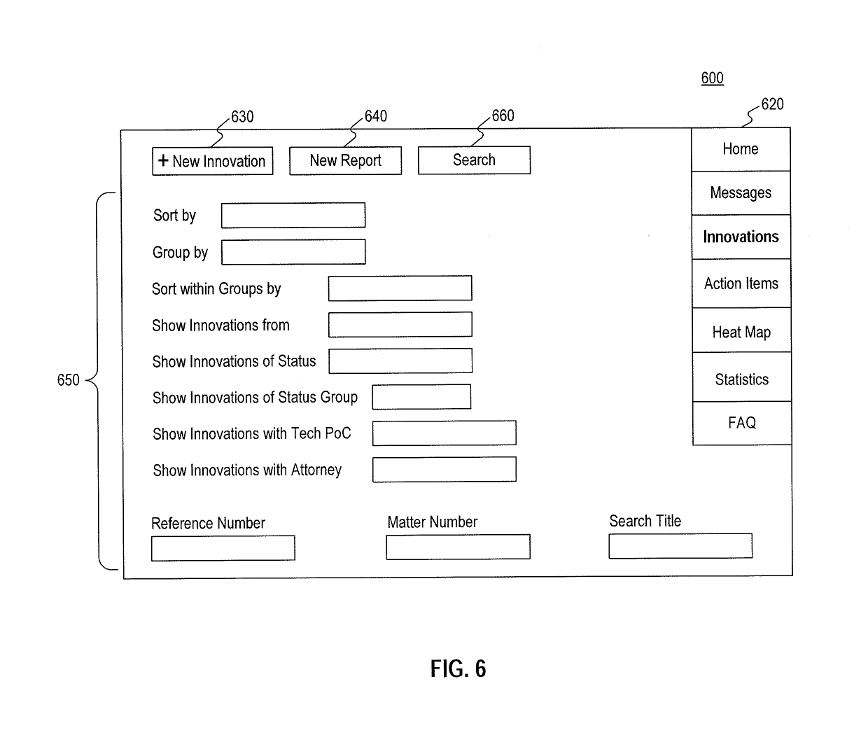

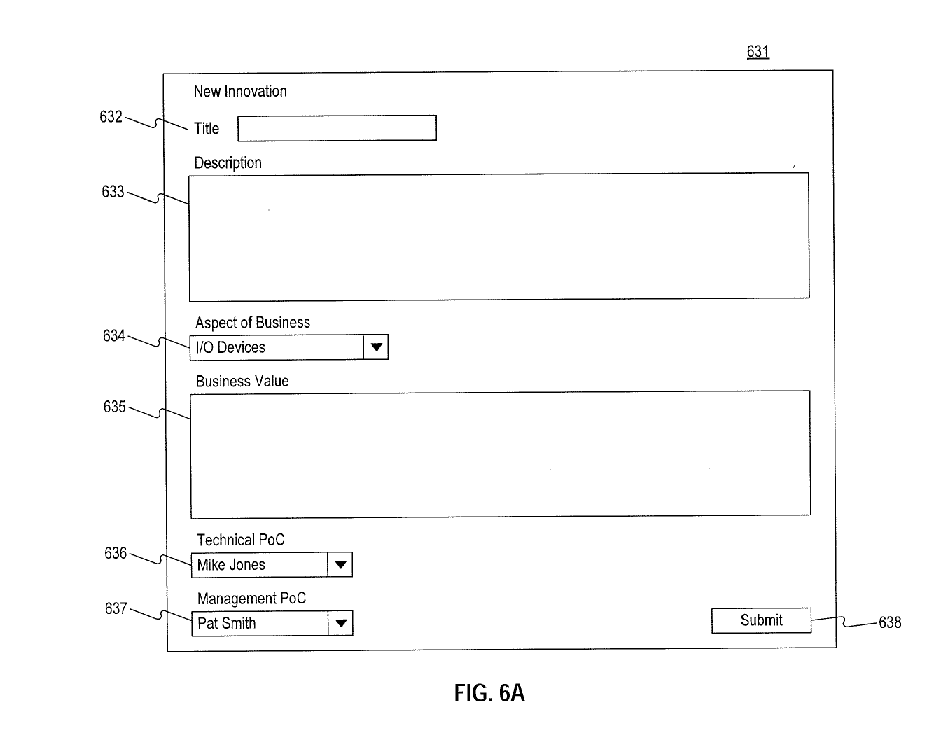

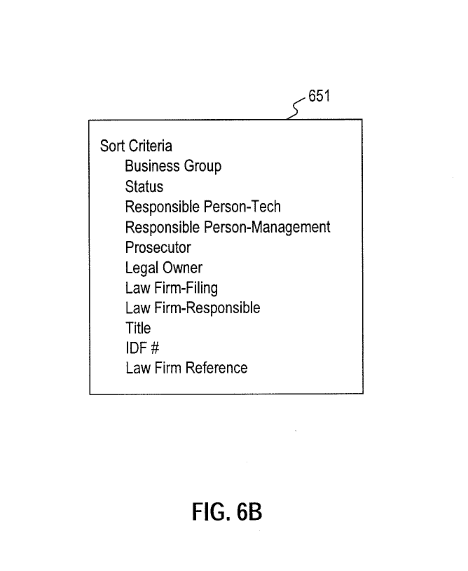

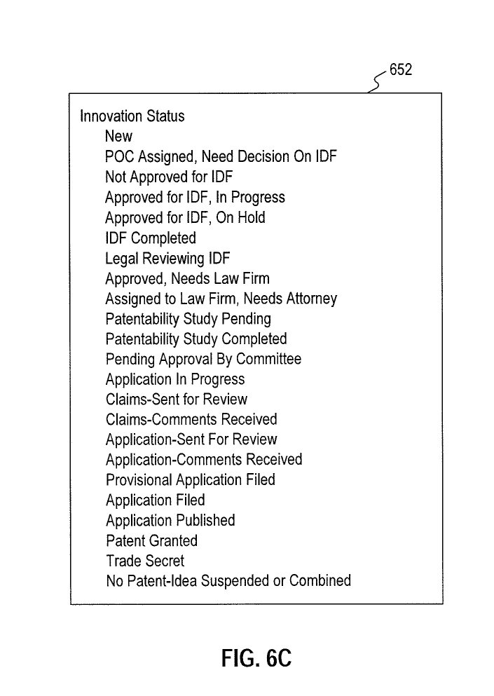

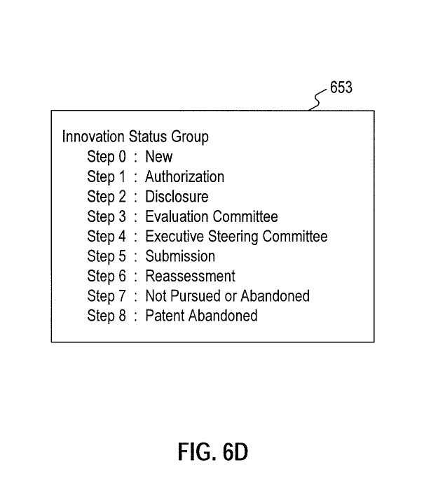

FIG. 6 is a screen shot of an exemplary user interface 600 for an IP management tool, consistent with embodiments of the present invention. As can be seen from navigational toolbar 620, user interface 600 shows an innovations interface. User interface 600 may include a new innovation button 630. If the user selects new innovation button 630, a user interface may be displayed prompting the user to enter information regarding a new innovation. For example, user interface 631, shown in FIG. 6A, may be displayed. User interface 631 may prompt the user to enter information regarding the new innovation. For example, user interface 631 includes innovation title field 632, innovation description field 633, business linking field 634, business value field 635, technical point of contact linking field 636, management point of contact field 637, and submit button 638.

A user submitting a new innovation may enter data into the different fields 632-637 and submit the information by selecting submit button 638. For example, the user may enter information linking the innovation to specific aspects of the business using business linking field 634. In certain embodiments, business linking field 634 may present the user with a predetermined list of products via a drop-down menu. The user may select from among the list of products to establish link(s) between the new innovation and corresponding products. In certain embodiments, the user may be able to select a preliminary linkage strength between the innovation and certain products. For example, if the innovation is particularly important to product A, the user may indicate a high strength of linkage between the innovation and product A. On the other hand, if the innovation is only marginally important to product B, the user may indicate a low or medium strength of linkage between the innovation and product B. In some embodiments, an innovation may be linked to multiple products.

A user may enter additional information regarding the innovation and its relationship to different aspects of the business in business value field 635. For example, business value field 635 may prompt the user to establish the features of a particular product with which the innovation corresponds. For example, if product A has features 1, 2, 3, and 4, the user may indicate that the particular innovation has a high correlation to feature 1, a medium correlation to feature 2, and no correlation to features 3 and 4. While high, medium, and low are used as examples of link strength, any indicator may be used, e.g., a color system, a scale from one to ten, etc. The user may also enter other data into business value field 635. This information may include, e.g., which problems the innovation was trying to solve, how much value the innovation adds to the business, the best way to protect the innovation to obtain the greatest competitive advantage, etc.

Referring again to FIG. 6, user interface 600 also includes new report button 640, search and sort criteria 650, and search button 660. New report button 640 may clear the search and sort criteria 650. For example, a user may reset the search and sort criteria 650 to their default settings by selecting new report button 640.

Search and sort criteria 650 may allow a user to enter text defining a search, choose from a predetermined list of criteria for each entry, or a combination. For example, the search and sort criteria 650 labeled “Sort by” may include a drop down menu from which the user may select how to sort the search results. FIG. 6B shows a screen shot of an exemplary user interface 651 that allows a user to choose from a predetermined list of search criteria. For example, user interface 651 allows a user to sort the search results by criteria such as business group, status, responsible person, title, etc.

The search and sort criteria 650 labeled “Show Innovations of Status” may also include a drop down menu from which the user may select which innovations to include in the search results. FIG. 6C shows a screen shot of an exemplary user interface 652 that allows a user to choose from a predetermined list of innovation status identifiers. For example, user interface 652 allows a user to display innovations that have a status of new, IDF completed, patent granted, trade secret, etc.

The search and sort criteria 650 labeled “Show Innovations of Status Group” may also include a drop down menu from which the user may select which innovations to include in the search results. FIG. 6D shows a screen shot of an exemplary user interface 653 that allows a user to choose from a predetermined list of innovation status group identifiers. The status group identifiers may sort innovations based on where they are in the IP management process. For example, user interface 652 allows a user to display innovations that have a status group of new, disclosure, submission, reassessment, etc.

While search and sort criteria 650 may use predetermined lists in some embodiments, as discussed above, others may allow the user to enter textual information. For example, the search and sort criteria 650 labeled “Reference Number” may allow a user to enter all or part of a reference number by which to search for a particular innovation. After the user has selected and/or entered search and sort criteria 650, the user may select search button 660 to initiate a search that will display innovations based on the search and sort criteria 650. One skilled in the art will appreciate that the lists of FIGS. 6B-6D may be used in multiple fields 650, etc.

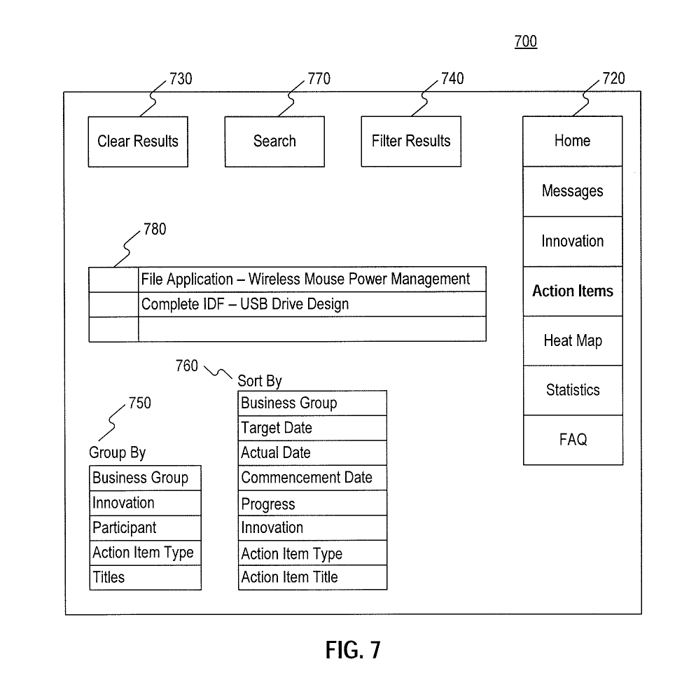

FIG. 7 is a screen shot of an exemplary user interface 700 for an IP management tool, consistent with embodiments of the present invention. As can be seen from navigational toolbar 720, user interface 700 shows an action items interface. A user may interact with user interface 700 to search action items for various innovations and determine their status.

User interface 700 includes a clear results button 730, which may clear the search results and allow a user to begin a new search. User interface 700 also includes a filter results button 740. By selecting filter results button 740, a user may be presented with a list of criteria by which to filter the search of action items. For example, a user may wish to limit the search to a particular type of action item, such as “file application.” Likewise, a user may wish to limit the search based on action item status, such as viewing only those action items that are pending or overdue. Additionally, a user may wish to limit the search to a particular individual. For example, a particular user may wish to view only action items for which that user is responsible.

User interface 700 also includes Group By criteria 750 and Sort By criteria 760. The user may select from among the Group By criteria 750 and Sort By criteria 760 to determine how the action items will be grouped and sorted within the groups. For example, by choosing group by “Innovation” and sort by “Target Date” a user can format the action item search results so that all results for a particular innovation are grouped together and displayed within their respective groups in order of target date. User interface 700 also includes a search button 770. After a user has selected criteria for filtering, grouping, and/or sorting, the user may initiate the search by selecting search button 770. User interface 700 also includes search results 780 which may display a result of the search.

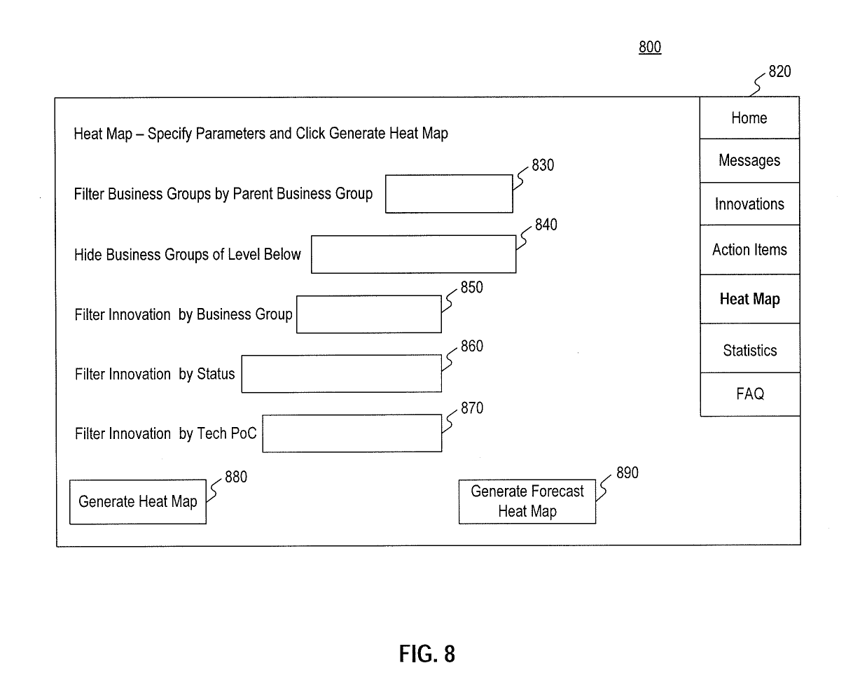

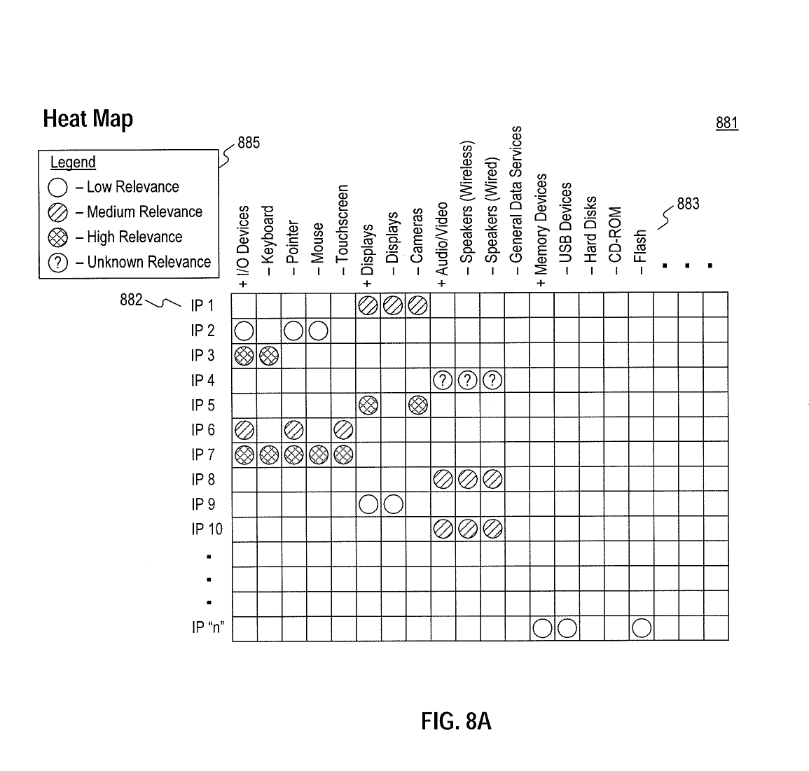

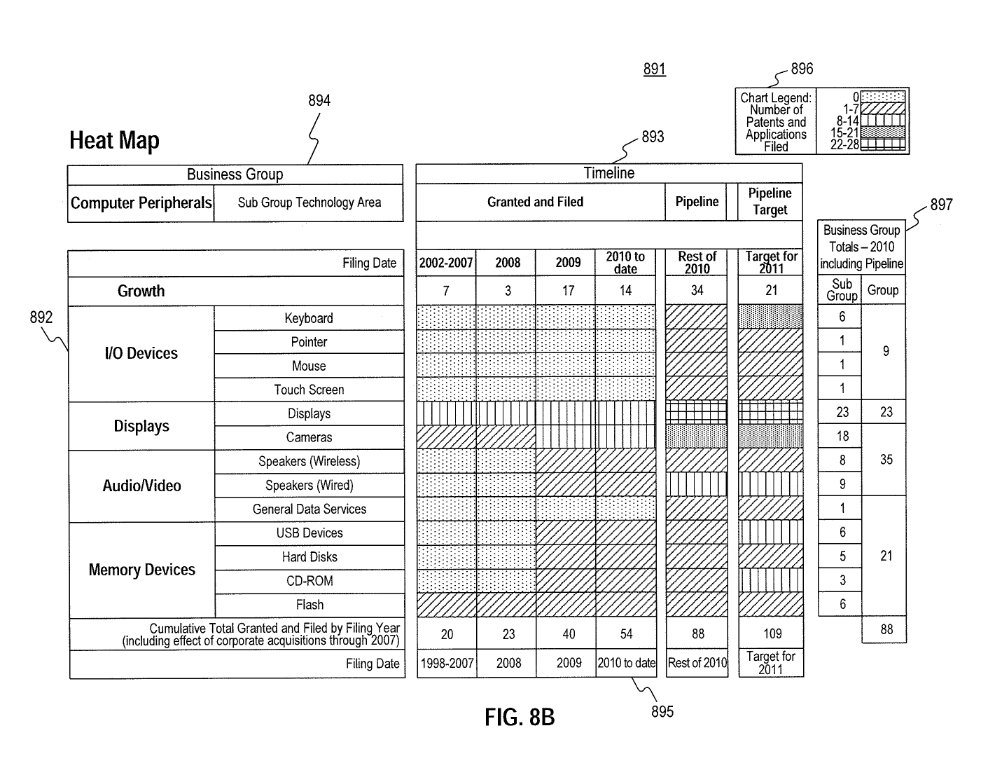

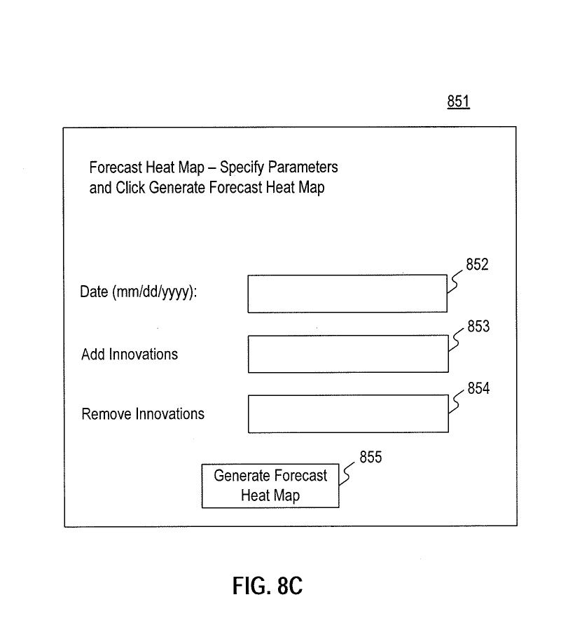

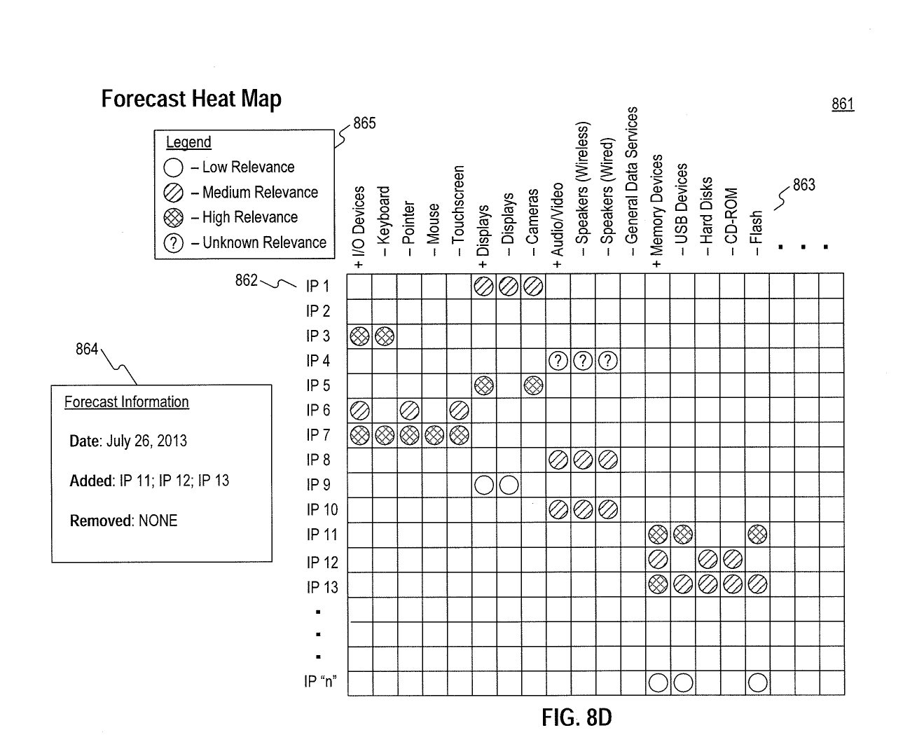

FIG. 8 is a screen shot of an exemplary user interface 800 for an IP management tool, consistent with embodiments of the present invention. As can be seen from navigational toolbar 820, user interface 800 shows a heat map interface. User interface 800 includes filter criteria 830-870, which allow a user to customize the heat map to be generated. For example, a user may choose which business groups are to be displayed on the heat map using “business groups by parent business group” filter criteria 830. Likewise, a user can determine how much detail the heat map will show with regards to the selected business groups using the “hide business groups of levels below” filter criteria 840.

For example, an organization that manufactures computer parts and accessories may have four different parent business groups: 1) input/output devices, 2) displays, 3) audio/video devices, and 4) memory devices. Each of those parent business groups may have one or more business groups. For example, the input/output devices parent business group may include four business groups: 1a) keyboard, 1b) pointer, 1c) mouse, and 1d) touchscreen. Further, each of those business groups may include business sub-groups. For example, the keyboard business group may include two business sub-groups: 1a1) wired keyboards; and 1a2) wireless keyboards. Still further, each of those sub-groups may design and manufacture one or more products. For example, the wired keyboard business sub-group may have several different models of wired keyboards.

By using “business groups by parent business group” filter criteria 830 and “hide business groups of levels below” filter criteria 840, a user can customize the level of detail displayed by the heat map. Using the example above, the user may only want to show the products produced by the wired keyboard business sub-group. Thus, the user may select “Input/Output Devices” as the parent group for search criteria 830 and select to hide groups of levels below the business sub-group level in search criteria 840.

In addition to filtering which aspects of the business are displayed in the heat map, the user may also choose to filter which types of innovations are displayed, based on criteria such as business group, status, technical point of contact, etc. For example, the user may select the keyboards business group in “innovation by business group” filter criteria 850 so that the heat map only shows innovations related to keyboards. On the other hand, the user may select all business groups so that the heat map shows all innovations within the organization.

The user may also use the “innovation by status” filter criteria 860 to filter the innovations based on their status. For example, the user may only wish to see innovations for which a patent has issued, or for which an innovation disclosure form has been submitted. Similarly, a user may use the “innovation by tech PoC” filter criteria 870 to filter the innovations based on their technical points of contact. For example, a user may wish to show a heat map that includes only innovations for which the user is a point of contact. After selecting the desired filter criteria 830-870, the user may select generate heat map button 880 to generate the customized heat map.

FIG. 8A shows an exemplary heat map 881 that may be generated by IP management tool 110. Heat map 881 enables a user to see innovations, such as IP assets, organized according to business unit, product, etc. Heat map 881 may further depict a strength of the links between assets and business in order to assist an organization in analyzing its portfolio. Heat map 881 includes aspects of the business listed along horizontal axis 883. As discussed with respect to FIG. 8, a user may customize the level of business detail shown along the horizontal axis. Heat map 881 lists innovations, e.g. IP1, IP2, etc., along the vertical axis 882. In some embodiments, heat map 881 shows an intersection between each innovation listed on the vertical axis 882 and each aspect of the business listed along horizontal axis 883. These intersections may represent a potential link between an innovation and a corresponding aspect of the business. The business aspects may include, e.g. business units, products, locations, business entities, etc.

As shown in legend 885 of heat map 881, different indicators may be used to demonstrate the strength of the link between the innovation and the aspect of the business. For example, legend 885 includes four levels of relevance: low, medium, high, and unknown. These levels may be indicated by different icons, as shown in legend 885. Visual cues, such as shading, coloring, etc., may be used to indicate the strength of the linkage between the innovation and the aspect of the business.

In this way, heat map 881 may demonstrate the strength of linkage between innovations and different aspects of the business. These links may have been established, for example, by the innovator when submitting the innovation. The links may also have been established and/or modified by other users, such as business stakeholders 120, technology stakeholders 150, IP committee 160, and/or legal team 130, based on a subsequent evaluation of a particular innovation, for example.

By using visual cues to demonstrate a strength of linkage between different innovations and aspects of the business, heat map 881 may provide a snapshot of where and how an organization is innovating, and allow the organization to shift resources based on business objectives. For example, in heat map 881, if the user chose the heat map criteria such that the innovations in vertical axis 882 show all of the patented inventions of an organization, the user would see that the business groups of “I/O Devices,” “Displays,” and “AudioNideo” shown in horizontal axis 882 are protected by more patented inventions than “Memory Devices.” Based on the evaluation of the heat map, business stakeholders may determine to invest more in research and development and/or in obtaining patent protection for innovations in the “Memory Devices” business group. Alternatively, the organization may identify “Memory Devices” as an area to seek to acquire patents.

FIG. 8B shows another exemplary heat map 891 that may be generated by IP management tool 110, consistent with embodiments of the present invention. Heat map 891 shows aspects of the business in column 892 and a timeline along row 893. Heat map 891 provides a visual depiction of protection for each of the different aspects of the business over time. For example, row 893 includes fields for past, current, and future years. Heat map 891 includes a visual depiction of patents granted for different aspects of the business in each of the past time periods, as well as a prediction for the future. In some embodiments, the content and level of detail displayed in heat map 891 may be customized based on user input. For example, as shown by Business Group section 894, heat map 891 is a heat map for the business group “Computer Peripherals.”

As shown in legend 896, different indicators may be used to demonstrate the strength of protection for a certain aspect of the business. For example, legend 896 includes five different levels to indicate how many patents were obtained in a given year for a particular aspect of the business. These levels may be indicated by visual cues, such as shading, coloring, etc.

Heat map 891 also includes a totals section 895 of the number of patents obtained in a given time period across all aspects of the business displayed in the heat map. Heat map 891 also includes business group totals section 897 which totals the number of patents obtained for an aspect of the business. Different levels of specificity may be shown in business group total section 897 based on the criteria that the user selects in generating the heat map, as discussed with regard to FIG. 8.

FIG. 8 also includes generate forecast heat map button 890. By clicking generate forecast heat map button 890, a user may be able to further customize the heat map by entering additional data regarding a future date, an innovation acquisition, and/or an innovation sale. For example, a user may enter all of the information into fields 830-870, as discussed above, and may then select generate forecast heat map button 890. FIG. 8C shows a screen shot for an exemplary user interface 851 that may appear, for example, if the user selects forecast heat map button 890. User interface 851 may prompt the user to enter forecast heat map information.

For example, the user may enter a date into date field 852. The user may enter the present date, for example, or may enter a future date. The user may also enter information regarding possible innovation acquisitions into add innovations field 853. For example, add innovations field 853 may allow a user to upload innovation data and/or innovation records for the potential innovation acquisitions. Similarly, the user may enter information regarding possible innovation sales into remove innovations field 854. For example, remove innovations field 854 may present the user with a list of current innovations. The user may then select which innovations, or groups of innovations, to remove from the heat map. After entering the additional forecasting information into fields 852-854, the user may select generate forecast heat map button 855.

Heat map generator 260 may generate a heat map based on the information entered by the user. If the user selected a date in the future, heat map generator 260 may use data generated by innovation statistics analyzer 295 to determine which innovations meet the user-selected criteria for that date. For example, if a user selects all patented innovations at a date three years in the future, heat map generator 260 may exclude all patents that innovation statistics analyzer 295 projects will be expired by that date. Similarly, heat map generator 260 may display the currently pending patent applications for which innovation statistics analyzer 295 projects a forecast issue date within the next three years.

Additionally, if the user has selected certain innovations to be added or removed, heat map generator 260 may also include those potential innovation acquisitions or sales when generating a forecast heat map. For example, if a user indicates that certain innovations or groups of innovations will be sold off, heat map generator 260 may take this into account by removing them from the heat map. Similarly, if the user indicates that new innovations or groups of innovations may be acquired or are a part of an internal innovation development target, heat map generator 260 may take this into account by adding these innovations to the heat map. As discussed above, for a potential acquisition of innovations, one or more users may enter innovation data, including a link between the to-be-acquired innovation and different aspects of the business and a strength of that link. Heat map generator 260 may use this information in generating the forecast heat map for the acquired innovations.

FIG. 8D shows a screen shot of an exemplary forecast heat map 861 consistent with embodiments of the present invention. Forecast heat map 861 enables a user to see innovations, such as IP assets, organized according to business unit, product, etc., at a user-specified date. Forecast heat map 861 may further depict a strength of the links between assets and business in order to assist an organization in analyzing its portfolio. Forecast heat map 861 includes aspects of the business listed along horizontal axis 863. As discussed with respect to FIG. 8, a user may customize the level of business detail shown along the horizontal axis. Forecast heat map 861 lists innovations, e.g. IP1, IP2, etc., along the vertical axis 862. In some embodiments, forecast heat map 861 shows an intersection between each innovation listed on the vertical axis 862 and each aspect of the business listed along horizontal axis 863. These intersections may represent a potential link between an innovation and a corresponding aspect of the business. The business aspects may include, e.g. business units, products, locations, business entities, etc.

Legend 865 may include icons that demonstrate the strength of linkage between the innovations and the different aspects of the business. While legend 865 uses different icons to demonstrate the strength of linkage, and visual cue may be used, e.g., color, shading, etc. Forecast heat map 861 also includes forecast information section 864. Forecast information section 864 may include the forecast date selected by the user, the innovations that have been added to demonstrate a potential acquisition or an internal innovation development target, and/or the innovations that have been removed to demonstrate a potential innovation sale.

For example, comparing forecast heat map 861 in FIG. 8D to heat map 881 in FIG. 8A shows that on Jul. 26, 2013, the innovation named “IP2” listed in vertical axis 862 will no longer be protected. While this is denoted in forecast heat map 861 by not displaying a link between “IP 2” and the aspects of the business, in certain embodiments, this may be denoted in other ways, e.g. by completely removing “IP 2” from vertical axis 862, by displaying “IP 2” in a different color or shade to indicate that it has expired, etc. Additionally, forecast heat map 861 shows that the three potential acquisitions, “IP 11,” “IP 12,” and “IP 13” added by the user would substantially increase the organization's patent protection in the Memory Devices business group.

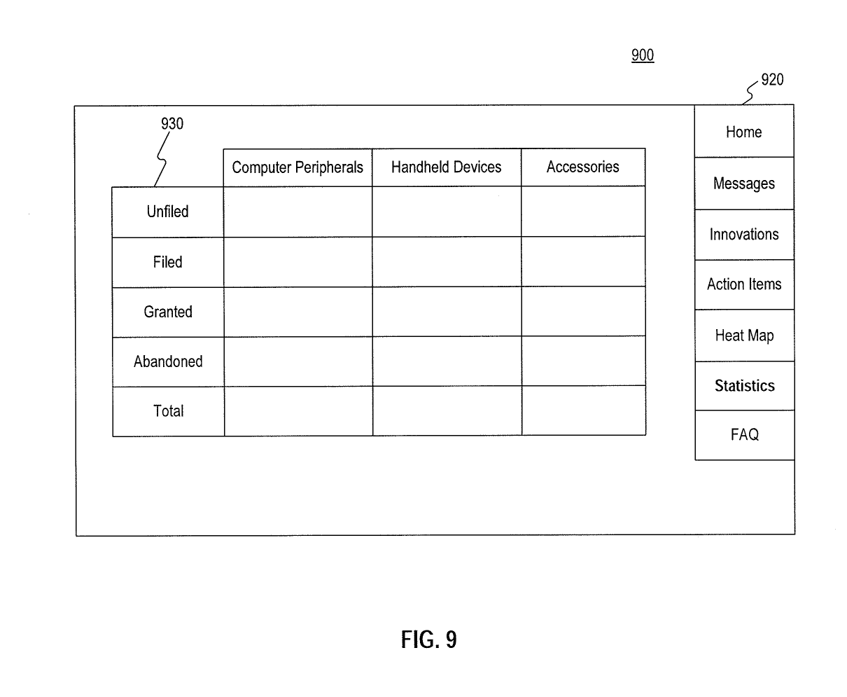

FIG. 9 shows a screen shot of an exemplary user interface 900, consistent with embodiments of the present invention. As shown by navigational toolbar 920, exemplary user interface 900 shows a statistics interface. User interface 920 may include a portfolio summary 930 that provides a high-level status of innovations managed by IP management tool 110, sorted by aspects of the business. The level of detail shown in the portfolio may be customizable by the user or by a system administrator. For example, the aspects of the business may be displayed with varying levels of granularity, e.g., “computer peripherals” may be further broken down into products such as mouse (wired), mouse (wireless), keyboard, etc.

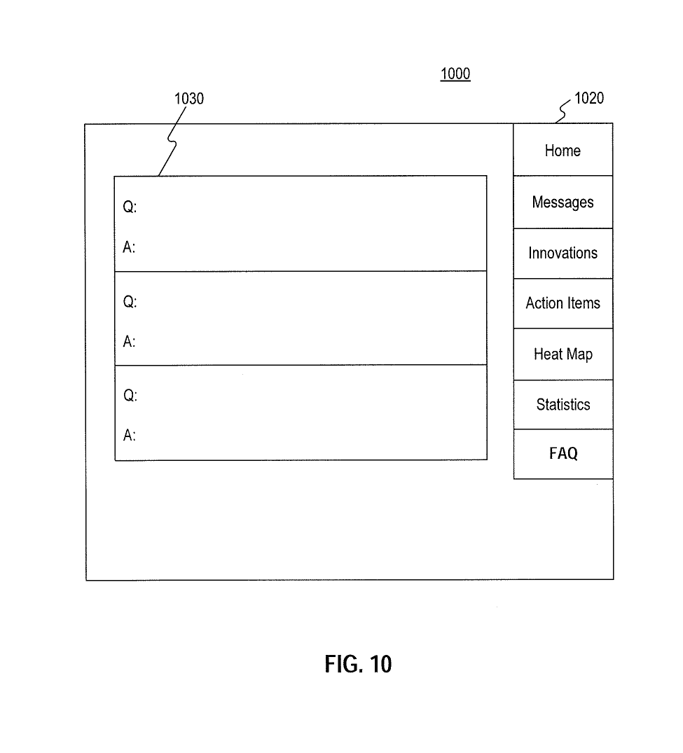

FIG. 10 shows a screen shot of an exemplary user interface 1000, consistent with embodiments of the present invention. As shown by navigational toolbar 1020, user interface 1000 is a Frequently Asked Questions interface. User interface 1000 may include Frequently Asked Questions section 1030, which may include a list of frequently asked questions regarding how to use IP management tool 110 and their corresponding answers.

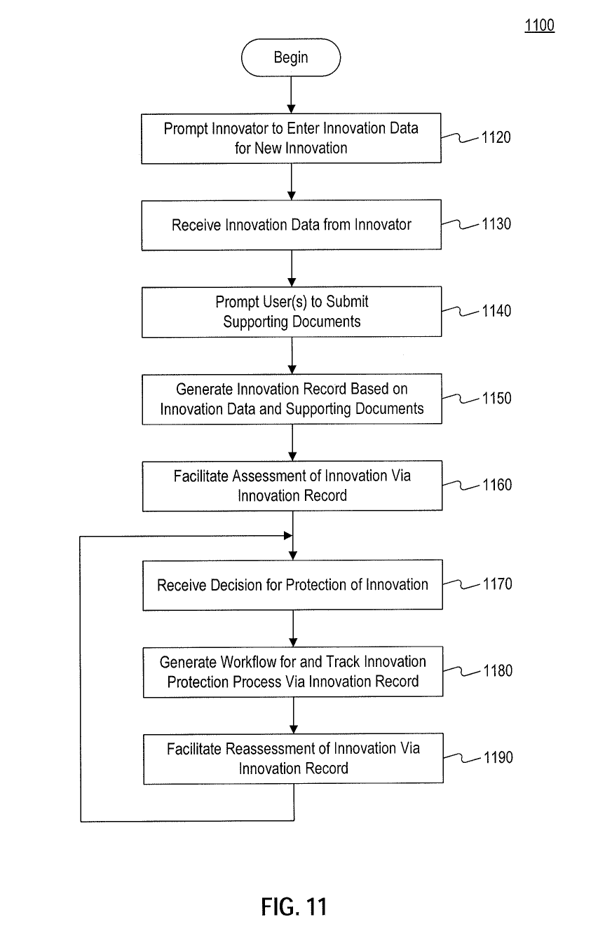

FIG. 11 shows an exemplary IP management process 1100, consistent with embodiments of the present invention. For example, IP management process 1100 may be performed by an IP management tool such as IP management tool 110, for example.

IP management tool 110 may prompt innovator 170 to enter innovation data for a new innovation (step 1120). For example, the tool may prompt a user to enter information such as the innovation's title, description, and importance to various aspects of the business. The tool may prompt innovator 170 to establish a link between the innovation and aspects of the business. For example, the tool may provide innovator 170 with a list of products produced by the organization and prompt innovator 170 to link the innovation to one or more of the products.

At step 1130, innovation data may be received from the innovator. For example, the tool may receive the innovation data and store it in a database with innovation data for other innovations. Users may be prompted to submit supporting documents for the innovation. For example, innovator 170 may be prompted to submit a document, such as an innovation disclosure form, that describes the innovation in more detail. Also, technical stakeholders 150 may be prompted to submit drawings, specifications, or other documents, and business stakeholders 120 may be prompted to submit financial reports or marketability studies for the proposed innovation.

At step 1150, the tool generates an innovation record based on the innovation data and supporting documents. The innovation record may include a summary of the data and/or documents submitted to facilitate review of the innovation. For example, the innovation record may be similar to the innovation record 300 shown in FIG. 3, using innovation records tool 230.

At step 1160, the tool may facilitate assessment of the innovation, for example, via the innovation record. For example, the tool may distribute the innovation record to different members of the organization, along with instructions for assessing the innovation via the innovation record. As discussed above, the tool may automatically generate these instructions and assign them to different members of the organization. Alternatively, or in combination, administrator 140 may add or remove tasks and assign the instructions to different members of the organization based on a particular innovation or group of innovations. For example, the instructions may prompt various members to perform such tasks as: reviewing the innovation disclosure form to make sure that all information is complete; if the innovation is a technical innovation, undertake a patentability study; and/or assess the link initially established by the innovator between the innovation and the different aspects of the business. Various members may also assess the innovation's initial value to the organization.

At step 1170, a decision is received regarding protection of the innovation. In some embodiments, the decision may be received from IP committee 160. For example, based on the assessment facilitated in step 1160, IP committee 160 may make a determination to pursue formal protection for the innovation, e.g., through patents, copyrights, trademarks, etc. IP committee 160 may also choose other protection mechanisms, e.g., trade secret, defensive publishing, etc. In some embodiments, a decision may include a suggestion, a vote for a decision, a request for more information, etc.

At step 1180, the tool generates a workflow for and tracks the innovation protection process via the innovation record. As discussed above, the workflow may be generated automatically by workflow processor 250, may be generated manually by a user, such as administrator 140, for example, or a combination of both. For example, in one embodiment, a template of the steps to be performed for the particular workflow may be generated automatically by workflow processor 250. Administrator 140 may customize the workflow based on the particular innovation. For example, administrator 140 may add or remove steps from the workflow. Administrator 140 may also define which users should be responsible for different steps within the workflow for a particular innovation or for a group of innovations associated with a particular project or aspect of the business.

For example, if the decision received in step 1170 is to pursue a patent for the innovation, the tool and/or administrator 140 may generate a workflow that includes action items for preparing, filing and prosecuting the application and may assign tasks within the workflow to different users. The workflow may be similar to the workflow in workflow section 330 shown in FIG. 3, for example. The tool may then track the innovation protection process as different users update the action items in the workflow, to indicate that they have completed certain action items. In another example, if the decision is to retain the innovation as a trade secret, the workflow may indicate instructions to mark the innovation as confidential, restrict access to the innovation record, etc.

At step 1190, the tool facilitates a reassessment of innovation via the innovation record. For example, the generated workflow may include action items for various members in the organization to reassess the innovation at different points in its lifecycle. For example, if a patent is being pursued for the innovation, the workflow may include an action item to review the innovation after the patent has issued, or at points during the life of the patent when maintenance fees are due. To facilitate reassessment in step 1190, the tool may prompt one or more members of an organization, such as an IP committee, for example, to review the innovation.

For example, in step 1190 the tool may prompt members to reassess the link between the innovation and different aspects of the business. For example, as new product lines enter the market or as old product lines cease to exist, the strength of the link between the innovation and different aspects of the organization's business may change. The tool may thus prompt different members in the organization to account for these dynamic situations by reassessing the innovation. In step 1190, the tool may also generate heat maps and/or forecast heat maps to facilitate the review of the innovation or of multiple innovations at a time. For example, the tool may generate heat maps similar to those shown in FIGS. 8A and 8B.

The tool then returns to step 1170 where a decision is received from the IP committee regarding protecting the innovation. For example, in a case where the innovation has been protected by a patent and at step 1190 when the tool facilitates a reassessment of the innovation it is determined that the innovation no longer has a strong link with any aspect of the business, the IP committee may decide to cease paying maintenance fees for the patent. In this case, when the tool proceeds to step 1180, the tool may generate a workflow that indicates that the patent is to be abandoned by not paying the next maintenance fee.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented innovation management method for an organization, the method comprising:
prompting an innovator via a user interface to provide innovation data regarding an innovation, the innovation data including a link between the innovation and one or more aspects of the organization;
receiving the innovation data from the innovator;
receiving innovation documents related to the innovation;
creating an innovation record in a database based on the innovation data and the innovation documents;
enabling assessment, by one or more assessors, of the link between the innovation and the one or more aspects of the organization based on the innovation record, wherein the assessment includes adjusting the link; and
generating a display depicting the link between the innovation and the one or more aspects of the organization based on the assessment.

2. The innovation management method according to claim 1, further comprising:
receiving a decision regarding protection of the innovation based on the assessment; and
automatically generating a workflow for the innovation based on the decision regarding the protection of the innovation, the workflow including tasks related to obtaining protection for the innovation.

3. The innovation management method according to claim 2, further comprising:
receiving an input that one or more of the tasks has been completed; and
updating the workflow for the innovation responsive to the input.

4. The innovation management method according to claim 3, further comprising:
prompting one or more of the assessors to reassess the link between the innovation and the aspects of the organization after the protection has been obtained.

5. The innovation management method according to claim 2, further comprising:
determining a strength of the link based on an initial strength input provided by the innovator, a value of the innovation to the business, and the assessment of the link by the one or more assessors; and
generating a report that depicts the strength of the link between the innovation and the aspects of the organization using visual cues.

6. The innovation management method according to claim 1, wherein the one or more aspects of the organization are products, and
prompting the innovator includes presenting the innovator with a predetermined list of the products via a drop down list displayed in the user interface and enabling the innovator to select at least one of the products from the drop down list in the user interface.

7. The innovation management method according to claim 6, further comprising:
receiving report configuration input indicating one or more products and one or more innovations; and
generating a report based on the report configuration input that demonstrates a strength of a link between each of the one or more products and each of the one or more innovations using visual cues.

8. The innovation management method according to claim 1, wherein
the link is adjusted before receiving a decision regarding protection of the innovation, and
adjusting the link includes one or more of the following:
removing the link between the innovation and a product to which the innovation is linked;
adding an additional link between the innovation and a product to which the innovation was not previously linked
removing the link between the innovation and a product feature to which the innovation is linked;
adding an additional link between the innovation and a product feature to which the innovation was not previously linked; and
changing the strength of the link.

9. The innovation management method according to claim 1, further comprising:
calculating a forecast protection date for the innovation that predicts when protection will begin for the innovation, the forecast protection date being based on a statistical analysis of previously protected innovations;
receiving report configuration input including a forecast report date that indicates a date for which a report is to be generated; and
generating a report based on the report configuration input that demonstrates a strength of a link between the innovation and the aspects of the organization using visual cues, wherein
if the forecast protection date is later than the forecast report date, the report indicates that no link exists between the innovation and the aspects of the organization.

10. An innovation management system for an organization comprising:
an innovation data tool that prompts an innovator to provide innovation data regarding an innovation through a user interface, the innovation data including a link between the innovation and one or more aspects of the organization; receives the innovation data from the innovator; receives an innovation document related to the innovation; and stores the innovation data and innovation document in a database;
an innovation records tool that generates an innovation record based on the innovation data and the innovation documents; and
an innovation analyzer that enables assessment, by one or more assessors, of the link between the innovation and the one or more aspects of the organization based on the innovation record, wherein
the assessment includes adjusting the link, and the innovation records tool updates the innovation record based on the assessment to depict the link between the innovation and the one or more aspects of the organization.

11. The innovation management system according to claim 10, further comprising:
a workflow processor that receives a decision regarding protection of the innovation and automatically generates a workflow including tasks related to obtaining protection for the innovation based on the decision regarding the protection of the innovation.

12. The innovation management system according to claim 11, wherein the workflow processor updates the workflow for the innovation responsive to an input that one or more of the tasks related to obtaining protection for the invention has been completed.

13. The innovation management system according to claim 12, wherein the workflow processor prompts one or more of the assessors to reassess the link between the innovation and the aspects of the organization after the protection has been obtained.

14. The innovation management system according to claim 11, wherein the innovation analyzer facilitates determining a strength of the link based on an initial strength input provided by the innovator, a value of the innovation to the business, and the assessment of the link by the one or more assessors, the system further comprising:
a heat map generator that generates a report depicting the strength of the link between the innovation and the aspects of the business using visual cues.

15. The innovation management system according to claim 10, wherein the one or more aspects of the business are products, and
the innovation data tool presents the innovator with a predetermined list of the products via a drop down menu in the user interface and instructs the innovator to choose at least one of the products from the drop down list in the user interface.

16. The innovation management method according to claim 15, further comprising:
a heat map generator that receives report configuration input indicating one or more products and one or more innovations, and generates a report based on the report configuration input demonstrating a strength of a link between each of the one or more products and each of the one or more innovations using visual cues.

17. The innovation management system according to claim 10, wherein
the link is adjusted before receiving a decision regarding protection of the innovation, and
adjusting the link includes one or more of the following:
removing the link between the innovation and a product to which the innovation is linked;
adding an additional link between the innovation and a product to which the innovation was not previously linked
removing the link between the innovation and a product feature to which the innovation is linked;
adding an additional link between the innovation and a product feature to which the innovation was not previously linked; and
changing the strength of the link.

18. The innovation management system according to claim 10, further comprising:
an innovation statistics analyzer that calculates a forecast protection date for the innovation that predicts when protection will begin for the innovation, the forecast protection date being based on a statistical analysis of previously protected innovations; and
a heat map generator that receives report configuration input including a forecast report date that indicates a date for which a report is to be generated, and generates a report based on the report configuration input that demonstrates a strength of a link between the innovation and the aspects of the organization using visual cues, wherein
if the forecast protection date is later than the forecast report date, the report generated by the heat map generator indicates that no link exists between the innovation and the aspects of the organization.

19. A computer-readable medium containing computer-readable code to cause a computer processor to execute an innovation management method for an organization, the innovation management method comprising:
prompting an innovator via a user interface to provide innovation data regarding an innovation, the innovation data including a link between the innovation and one or more aspects of the organization;
receiving the innovation data from the innovator;
receiving innovation documents related to the innovation;
creating an innovation record in a database based on the innovation data and the innovation documents;
enabling assessment, by one or more assessors, of the link between the innovation and the one or more aspects of the organization based on the innovation record, wherein the assessment includes adjusting the link; and
generating a display depicting the link between the innovation and the one or more aspects of the organization based on the assessment.

20. The computer-readable medium containing computer-readable code according to claim 19, the innovation management method further comprising:
receiving a decision regarding protection of the innovation based on the assessment; and
automatically generating a workflow for the innovation based on the decision regarding the protection of the innovation, the workflow including tasks related to obtaining protection for the innovation.

21. The computer-readable medium containing computer-readable code according to claim 20, the innovation management method further comprising:
receiving an input that one or more of the tasks has been completed;
updating the workflow for the innovation responsive to the input; and
prompting one or more of the assessors to reassess the link between the innovation and the aspects of the organization after the protection has been obtained.

22. The computer-readable medium containing computer-readable code according to claim 20, the innovation management method further comprising:
determining a strength of the link based on an initial strength input provided by the innovator, a value of the innovation to the business, and the assessment of the link by the one or more assessors; and
generating a report that depicts the strength of the link between the innovation and the aspects of the organization using visual cues.

23. The computer-readable medium containing computer-readable code according to claim 19, wherein the one or more aspects of the organization are products, and
prompting the innovator includes presenting the innovator with a predetermined list of the products via a drop down list displayed in the user interface and enabling the innovator to select at least one of the products from the drop down list in the user interface.

24. The computer-readable medium containing computer-readable code according to claim 23, the innovation management method further comprising:
receiving report configuration input indicating one or more products and one or more innovations; and
generating a report based on the report configuration input that demonstrates a strength of a link between each of the one or more products and each of the one or more innovations using visual cues.

25. The computer-readable medium containing computer-readable code according to claim 19, wherein
the link is adjusted before receiving a decision regarding protection of the innovation, and
adjusting the link includes one or more of the following:
removing the link between the innovation and a product to which the innovation is linked;
adding an additional link between the innovation and a product to which the innovation was not previously linked
removing the link between the innovation and a product feature to which the innovation is linked;
adding an additional link between the innovation and a product feature to which the innovation was not previously linked; and
changing the strength of the link.

26. The computer-readable medium containing computer-readable code according to claim 19, the innovation management method further comprising:
calculating a forecast protection date for the innovation that predicts when protection will begin for the innovation, the forecast protection date being based on a statistical analysis of previously protected innovations;
receiving report configuration input including a forecast report date that indicates a date for which a report is to be generated; and
generating a report based on the report configuration input that demonstrates a strength of a link between the innovation and the aspects of the organization using visual cues, wherein
if the forecast protection date is later than the forecast report date, the report indicates that no link exists between the innovation and the aspects of the organization.
